(19) United States
(12) Patent Application Publication
(10) Pub. No.: US 2026/0165289 A1
(43) Pub. Date: Jun. 18, 2026

(54) VEHICLE WINDOW INSERT FOR PET SAFETY

(71) Applicant: Arthur Simpson, Lithonia, GA (US)

(72) Inventor: Arthur Simpson, Lithonia, GA (US)

(21) Appl. No.: 19/419,325

(22) Filed: Dec. 15, 2025

Related U.S. Application Data
(60) Provisional application No. 63/733,718, filed on Dec. 13, 2024.

(51) Int. Cl. A01K 1/02; A01K 1/00

(52) U.S. Cl. CPC A01K 1/0272; A01K 1/0064; A01K 1/007; A01K 1/0245

(57) ABSTRACT

A vehicle window insert device may comprise a frame configured to attach between a vehicle window and a vehicle door. A mesh screen may be coupled to the frame and configured to allow airflow while preventing a pet from exiting the vehicle. At least one solid panel may be coupled to the frame and configured to provide a physical barrier. An attachment mechanism may be configured to secure the frame to the vehicle window and the vehicle door. The frame may comprise a plurality of hinged segments configured to fold into a substantially flat configuration for storage. The attachment mechanism may comprise at least one hook configured to engage a top edge of the vehicle window and at least one side clamp configured to engage a window frame. A retractable cover shade may be configured to selectively cover at least a portion of the mesh screen.

### RELATED APPLICATION

Under provisions of 35 U.S.C. § 119 (e), the Applicant claims benefit of U.S. Provisional Application No. 63/733,718 filed on Dec. 13, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to vehicle accessories and pet safety devices. More specifically, the disclosure pertains to window inserts for vehicles designed to enhance the safety and enjoyment of pets during stays in a car or other vehicle.

### BACKGROUND

Pet transportation in vehicles presents operational challenges for vehicle occupants. Dogs frequently experience confinement stress during vehicle travel. Traditional restraint systems restrict animal movement entirely. Complete freedom of movement creates safety hazards for both animals and vehicle occupants.

Vehicle window systems in passenger automobiles typically consist of movable glass panels. These panels can be lowered into door cavities. Lowered windows provide ventilation to vehicle interiors. Animals can extend their heads through fully opened windows. This configuration exposes animals to external hazards. Flying debris can strike unprotected animals. Insects can contact animal facial areas. Rain can enter vehicle interiors through open windows.

Full window closure eliminates these hazards. Closed windows also eliminate airflow benefits. Animals cannot experience external air circulation with closed windows. This restriction can increase animal stress levels during travel.

Partial window opening provides limited solutions. Small opening gaps permit airflow. These gaps do not accommodate animal head extension. Larger gaps permit head extension. Larger gaps also permit complete animal body passage through the opening. Unrestrained animals can exit vehicles through such openings. This creates injury risks and animal loss scenarios.

Existing vehicle pet barriers attach to various vehicle locations. Some barriers separate cargo areas from passenger compartments. Other barriers restrict animal access to front seating areas. These devices do not address window-related containment issues.

Removable window inserts exist for specific applications. Some inserts provide ventilation while blocking complete opening access. These inserts typically mount as permanent or semi-permanent installations. Installation procedures often require tools. Removal procedures can be time-consuming.

Vehicle window frames define the perimeter of window openings. Glass panels slide within channel guides in these frames. The channels maintain glass panel alignment during movement. Weather seals in the channels prevent water and air infiltration when windows are closed.

Vehicle window dimensions vary among vehicle models. Manufacturers design window openings with specific height and width measurements. These measurements differ between sedans and sport utility vehicles. Truck window openings have different proportions than passenger car openings.

Different vehicle types accommodate different animal sizes. Small dogs require less vertical clearance than large dogs. Medium-sized dogs need intermediate opening dimensions. Very large dog breeds require maximum opening dimensions.

Pet owners transport dogs of varying sizes in vehicles. A single window opening dimension cannot accommodate all dog sizes optimally. Fixed opening sizes restrict usage to specific animal size ranges. Owners of multiple dogs with different sizes face accommodation challenges.

Standard vehicle windows provide uniform opening sizes. These uniform sizes do not adjust to individual animal dimensions. A window opening suitable for a small terrier provides excessive space. The same opening provides insufficient space for a large retriever.

Vehicle aesthetics influence window design choices. Large openings in window panels can compromise visual appearance. Small openings may appear disproportionate on larger vehicles. Window opening size affects the overall visual balance of the vehicle exterior.

Structural integrity of window assemblies depends on glass panel geometry. Large cutouts in glass panels can reduce structural strength. The remaining glass area must maintain adequate rigidity. Edge distances around openings affect stress distribution in the glass.

Temperature variations affect animal comfort during travel. Hot weather conditions increase the need for airflow. Cold weather conditions require reduced air exposure. Rain conditions necessitate protection from water entry while maintaining some ventilation.

Direct sunlight through window openings can cause discomfort. Unshaded openings expose animals to intense solar radiation. Prolonged sun exposure can lead to overheating. Glare from direct sunlight can affect animal vision and comfort.

Privacy concerns arise with open vehicle windows. Passersby can view vehicle interiors through large openings. Animals visible through openings may attract unwanted attention. Some owners prefer to limit exterior visibility into their vehicles.

Security considerations affect window opening designs. Large openings could permit unauthorized access to vehicle interiors. Valuable items inside vehicles become visible through openings. Theft prevention requires limiting access through window openings.

Manufacturing processes for vehicle glass involve specific techniques. Tempered glass cannot be cut after the tempering process. Cutting must occur before tempering treatments. This sequence limitation affects customization possibilities for existing windows.

Installation complexity affects user adoption of window accessories. Devices requiring permanent modifications deter many users. Reversible installation methods appeal to broader user groups. Rental vehicles and leased vehicles cannot accommodate permanent modifications.

Storage space in vehicles is limited. Large accessories consume valuable cargo area when not in use. Bulky items are difficult to store in passenger compartments. Compact storage configurations are preferable for frequently used accessories.

Seasonal usage patterns affect accessory requirements. Summer months see increased pet travel frequency. Winter usage may be limited in cold climates. Year-round utility requires weather-appropriate features.

Cleaning and maintenance requirements affect long-term usability. Accessories exposed to outdoor elements accumulate dirt and debris. Mesh materials can trap particles and require regular cleaning. Difficult-to-clean designs discourage consistent use.

Noise generation from wind passing through openings can be problematic. High-speed travel amplifies wind noise through mesh screens. Whistling or fluttering sounds can distract drivers. Aerodynamic design affects noise levels.

Compatibility with existing vehicle features presents challenges. Power window mechanisms occupy space in door panels. Window channel configurations vary among manufacturers. Accessory designs must accommodate these variations without interference.

Regulatory compliance requirements apply to vehicle modifications. Some jurisdictions restrict alterations to safety equipment. Window systems may be classified as safety-related components. Compliance verification can be complex for aftermarket accessories.

Durability under repeated use cycles is necessary. Daily users may operate accessories multiple times per day. Mechanical components experience wear from frequent cycling. Material fatigue can occur in high-use scenarios.

Cost considerations influence purchasing decisions. Expensive accessories limit market accessibility. Manufacturing costs affect retail pricing. Material selection impacts both cost and performance characteristics.

Weight distribution in vehicle doors affects operation. Added weight to door-mounted accessories can strain hinges. Door closing force requirements may increase. Window regulator mechanisms may experience additional load.

Attachment point strength varies across door structures. Some door areas provide robust mounting locations. Other areas have limited structural support. Attachment methods must match available structural capabilities.

Visibility requirements for drivers must be maintained. Accessories cannot obstruct required sight lines. Mirror visibility must remain uncompromised. Blind spot considerations affect permissible accessory locations.

Child safety concerns arise with window-mounted devices. Young children may attempt to interact with accessible mechanisms. Pinch points present injury hazards. Supervision requirements increase with complex mechanisms.

Multi-pet households face coordination challenges. Different animals may have conflicting preferences. Simultaneous use by multiple animals requires adequate opening sizing. Territorial behaviors between animals can complicate shared access.

Training requirements for pet usage affect adoption. Some animals readily use window openings. Other animals require extended acclimation periods. Behavioral differences among individual animals affect success rates.

Vehicle resale value considerations influence modification decisions. Permanent alterations may decrease vehicle value. Reversible accessories preserve original configurations. Future owners may not desire pet-specific modifications.

Insurance implications may arise from vehicle modifications. Some policies exclude coverage for modified vehicles. Liability questions emerge from accessory-related incidents. Documentation requirements may apply to certain modifications.

Theft of accessories from vehicles presents concerns. Valuable accessories left in vehicles attract thieves. Quick-removal designs facilitate both legitimate and illegitimate removal. Security features add complexity and cost.

Therefore, there is a need for a window barrier system that permits controlled pet access to exterior air while maintaining vehicle containment, accommodates varying animal sizes across different vehicle configurations, provides adjustable environmental protection without permanent vehicle modification, enables rapid installation and removal without specialized tools, maintains structural integrity under applied forces, and offers compact storage when not in use.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A vehicle window insert device may be provided. The device may comprise a frame configured to attach between a vehicle window and a vehicle door. A mesh screen may be coupled to the frame and may be configured to allow airflow while preventing a pet from exiting the vehicle. At least one solid panel may be coupled to the frame and may be configured to provide a physical barrier. An attachment mechanism may be configured to secure the frame to the vehicle window and the vehicle door.

A vehicle window safety system may be provided. The system may comprise a collapsible frame configured to attach to a vehicle window opening. A barrier structure may be coupled to the frame. The barrier structure may comprise a mesh portion configured to permit airflow and a solid portion configured to provide weather protection. An attachment assembly may be configured to secure the frame to the vehicle at multiple contact points. A movable cover may be configured to provide selective coverage of the mesh portion.

A pet safety apparatus for vehicle windows may be provided. The apparatus may comprise a rectangular frame configured to span a vehicle window opening. A mesh screen may be attached to the frame and may have openings sized to prevent passage of a pet's head while permitting airflow. Solid panels may be attached to the frame and may comprise at least side panels and a top panel. An attachment mechanism may comprise adjustable hooks and clamps configured to secure the frame to a vehicle window and door frame. A folding mechanism may be configured to collapse the frame into a substantially flat storage configuration.

A method of securing a pet in a vehicle with an open window may be provided. The method may comprise unfolding a collapsible frame from a storage configuration to an expanded configuration. The method may comprise positioning the frame within a vehicle window opening. The method may comprise engaging an attachment mechanism to secure the frame between a vehicle window and a door frame. The attachment mechanism may comprise hooks and clamps. The method may comprise positioning a pet adjacent to a mesh screen coupled to the frame. The mesh screen may be configured to allow the pet to experience airflow while preventing exit from the vehicle. The method may comprise selectively deploying a movable cover to provide weather protection over the mesh screen.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 shows a rear perspective view of a vehicle window insert of the present disclosure, installed in a vehicle;

FIG. 2 shows an exterior side view of the vehicle window insert of FIG. 1, installed in a vehicle;

FIG. 3 shows an interior side view of the vehicle window insert of FIG. 1, installed in a vehicle;

FIG. 4 shows a front view of the vehicle window insert of FIG. 1, in a compact flat configuration; and

FIG. 5 shows a side view of the vehicle window insert of FIG. 1, in a compact flat configuration.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The device, system, and apparatus disclosed herein may address a technical problem that has persisted in the field of pet transportation safety. Pet owners may desire to provide their pets with an enjoyable travel experience that includes sensory stimulation from outdoor air and visual engagement with the surrounding environment. However, conventional approaches may fail to adequately balance this desire with the need to maintain pet safety and vehicle integrity.

A primary technical problem may arise when a pet owner attempts to allow a pet to experience open-air travel through a vehicle window opening. If the window opening remains unobstructed, the pet may be exposed to multiple hazards. The pet may attempt to exit the vehicle through the opening, potentially resulting in injury or loss of the pet. Flying debris such as rocks, insects, or other particulate matter may strike the pet, causing injury to sensitive areas such as the eyes or nose. Additionally, when the vehicle is stationary, passersby may be able to reach through the opening to interact with the pet in an unsupervised manner, potentially causing distress to the pet or creating liability concerns for the owner.

Conversely, if the pet owner maintains the window in a fully closed position or restricts the pet using conventional restraint systems such as harnesses or crates, the pet may be denied the sensory enrichment that outdoor air and visual stimulation may provide. This restriction may lead to increased stress or anxiety in the pet during travel. The pet may exhibit behavioral problems such as excessive vocalization, restlessness, or attempts to escape from the restraint system.

Another technical problem may involve the protection of the vehicle interior from environmental elements. When a window opening is left unobstructed to allow pet access, rain, snow, wind-blown debris, and insects may enter the vehicle cabin. This intrusion may damage interior surfaces, create unsanitary conditions, or cause discomfort to human occupants. Moisture entering through the opening may lead to mold growth or deterioration of upholstery and electronic components.

The device disclosed herein may solve these technical problems by providing a controlled barrier system that permits selective passage of air while blocking passage of the pet's body, environmental hazards, and unauthorized external contact. The mesh screen component may allow air molecules to pass through openings sized to provide substantial airflow, while simultaneously preventing passage of the pet's head beyond a safe extension point. The mesh openings may be dimensioned such that the pet cannot force its entire head or body through the barrier, thereby containing the pet within the vehicle while allowing sensory engagement with the exterior environment.

A specific use case scenario may illustrate the technical problem and solution. A pet owner may be transporting a medium-sized dog in a sedan on a warm, sunny day. The owner may desire to provide the dog with access to outdoor air for cooling and sensory stimulation. Without the disclosed device, the owner may face a choice between fully opening the window, which may allow the dog to exit or be struck by debris, or keeping the window closed, which may cause the dog to overheat and become distressed.

By installing the disclosed device in the vehicle window opening, the owner may create a controlled access point. The dog may extend its head through the mesh screen to experience the airflow and observe the passing scenery. The mesh openings may be sized to allow the dog's snout to protrude slightly while preventing the dog's entire head from passing through. If the dog attempts to push further through the opening, the mesh material may resist deformation and the frame may remain securely attached to the vehicle structure.

During travel, the vehicle may encounter varying weather conditions. If rain begins to fall, the top panel may deflect water away from the mesh opening, preventing moisture from entering the vehicle interior. The owner may deploy the retractable cover shade to provide additional protection over the mesh screen if the rain intensifies. The side panels may block wind-driven rain from entering laterally, maintaining a dry environment within the vehicle cabin.

When the vehicle stops at a traffic light or in a parking area, pedestrians may observe the dog's head extending through the device. The solid side panels and top panel may prevent these individuals from reaching the dog from the sides or above. The mesh screen may prevent direct contact from the front, as the mesh openings may be too small for human fingers to pass through easily. This configuration may protect the dog from unwanted interaction while still allowing the dog to observe and smell the surrounding environment.

Another scenario may involve a pet owner transporting a small dog in a sport utility vehicle on a highway. The vehicle may be traveling at high speed, creating substantial airflow past the window opening. Without the disclosed device, debris such as small rocks or insects may be propelled through the open window at high velocity, potentially striking the dog or entering the vehicle interior.

The disclosed device may address this scenario by positioning the mesh screen to intercept such debris. Particles larger than the mesh openings may impact the mesh surface and be deflected away from the dog and vehicle interior. Smaller particles such as dust may pass through the mesh but at reduced velocity due to the air resistance created by the mesh structure. The dog may still receive substantial airflow for cooling and olfactory stimulation, but the risk of injury from high-velocity debris may be significantly reduced.

A further scenario may involve a pet owner who frequently travels with a large dog that has a tendency to push forcefully against barriers. The owner may be concerned that conventional window screens or barriers may not withstand the force applied by the dog. The disclosed device may address this concern through the structural design of the frame and attachment mechanism.

The frame may be constructed from materials such as aluminum alloy or reinforced plastic that provide high strength-to-weight ratios. The frame members may be dimensioned to resist bending or deformation under the forces typically applied by a large dog. The attachment mechanism may include multiple hooks and clamps distributed around the frame perimeter, with each attachment point capable of resisting a portion of the total force. If the dog applies a force of 150 pounds to the mesh screen, this force may be distributed across six attachment points, with each point experiencing approximately 25 pounds of force. This distribution may prevent any single attachment point from failing while also preventing damage to the vehicle structure.

The device may also address a technical problem related to storage and portability. Pet owners may be reluctant to use safety devices that are bulky or difficult to store when not in use. The disclosed device may incorporate a folding mechanism that allows the frame to collapse to a substantially flat configuration. When folded, the device may occupy a thickness of only 1 to 3 inches, allowing it to be stored in a vehicle trunk or cargo area without consuming excessive space. The folding mechanism may include hinges at corner joints that allow the frame members to rotate relative to one another. Locking mechanisms may secure the frame in both the deployed configuration and the folded configuration, preventing unintended movement between states.

A scenario involving changing weather conditions may further illustrate the technical solution. A pet owner may begin a journey on a clear day with the device installed and the retractable cover shade in the retracted position, allowing maximum airflow through the mesh screen. As the journey progresses, clouds may form and rain may begin to fall. The owner may deploy the retractable cover shade by pulling it downward over the mesh screen. The shade material may be water-resistant, providing an additional barrier against moisture intrusion. If the rain intensifies, the owner may choose to fully close the vehicle window, removing the device from the opening. The quick-release mechanisms on the attachment system may allow the owner to detach the device rapidly without requiring tools.

The device may also solve a technical problem related to temperature regulation within the vehicle. On hot days, the interior of a parked or slowly moving vehicle may reach temperatures that are dangerous for pets. Conventional solutions may involve leaving windows partially open, which may create security concerns or allow the pet to escape. The disclosed device may allow the owner to lower the window significantly while maintaining pet containment. The mesh screen may permit substantial airflow to enter the vehicle, promoting air circulation and heat dissipation. The transparent or translucent side panels may allow light to enter while blocking direct sun exposure to the pet. If the side panels include UV-blocking coatings, they may reduce the amount of solar heat gain entering through the device.

A scenario involving multiple pets may present additional technical challenges. An owner may be transporting two dogs of different sizes in the same vehicle. The larger dog may be able to extend its head further through the mesh opening than the smaller dog. The mesh opening size may be selected to accommodate the larger dog's head while still preventing the dog's body from passing through. The smaller dog may also be able to extend its head through the same opening safely. The device may thus provide a solution that accommodates pets of varying sizes without requiring multiple different devices.

The device may address a technical problem related to vehicle compatibility. Different vehicle models may have window openings of varying dimensions and configurations. A device designed for a specific vehicle model may not fit properly in other vehicles, limiting its utility for owners who have multiple vehicles or who change vehicles over time. The disclosed device may incorporate adjustable features such as telescoping frame sections that allow the device dimensions to be modified. An owner may extend or retract these telescoping sections to match the width and height of different vehicle window openings. Locking mechanisms may secure the telescoping sections in the adjusted positions, maintaining the device's structural integrity across different dimensional configurations.

Another technical problem may involve the durability of the device under repeated use and exposure to environmental conditions. A device that degrades quickly may require frequent replacement, creating inconvenience and expense for the owner. The disclosed device may be constructed from materials selected for their resistance to environmental degradation. The mesh screen may be fabricated from nylon fibers treated with UV-resistant coatings, or from stainless steel wire that resists corrosion. The solid panels may be made from acrylic or polycarbonate plastics that maintain their structural properties and optical clarity over extended periods of outdoor exposure. The frame may be constructed from aluminum alloy with anodized or powder-coated finishes that prevent corrosion. These material selections may allow the device to withstand years of regular use without significant degradation in performance or appearance.

A scenario involving nighttime travel may present unique considerations. During evening or nighttime driving, visibility may be reduced. The transparent or translucent panels of the device may allow interior vehicle lighting to illuminate the pet, making the pet visible to the driver and to external observers. This visibility may enhance safety by allowing the driver to monitor the pet's condition and by making other drivers aware of the pet's presence near the window opening. Alternatively, if the owner desires to reduce the pet's visibility for security reasons, opaque panels may be substituted for the transparent panels.

The present disclosure includes many aspects and features. Moreover, while many aspects and features relate to, and are described in, the context of a pet-safety vehicle window insert device, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The device disclosed herein may provide a solution that addresses the competing needs of pet safety, pet comfort, and vehicle protection during travel. The device may allow a pet to experience the sensory benefits of open-air travel while maintaining physical containment within the vehicle. The mesh screen component may permit airflow to pass through the device opening while simultaneously preventing the pet's body from passing through the same opening. This selective permeability may be achieved through careful dimensioning of the mesh openings relative to the size of the pet's head and body.

The solid panel components may provide protection from environmental elements that could otherwise enter the vehicle through the window opening. Rain may be deflected by the top panel, which may extend over the mesh screen area. Wind-driven precipitation may be blocked by the side panels, which may extend along the lateral edges of the device. The combination of mesh and solid panels may create a controlled environment at the window opening that balances ventilation with weather protection.

The attachment mechanism may secure the device to the vehicle structure without requiring permanent modification of the vehicle. The hooks and clamps may engage with existing vehicle features such as the window glass, door frame, and windowsill. This temporary attachment approach may allow the device to be installed when needed and removed when not in use. The device may be transferred between different vehicles by adjusting the frame dimensions and attachment points to match each vehicle's specific window configuration.

The folding capability of the frame may address storage concerns that could otherwise discourage regular use of the device. When folded, the device may occupy a volume small enough to fit in a vehicle trunk alongside other cargo. The folding mechanism may allow the frame to transition between a deployed three-dimensional configuration and a collapsed substantially flat configuration. This transformation may be accomplished through hinges at the frame corners and mid-frame locations, combined with locking mechanisms that secure the frame in each configuration.

The retractable cover shade may provide user control over the level of environmental exposure. In mild weather conditions, the shade may be retracted to maximize airflow through the mesh screen. If weather conditions change during travel, the user may deploy the shade to provide additional protection without removing the entire device from the vehicle. This adjustability may enhance the device's utility across varying weather conditions and user preferences.

The device may accommodate pets of different sizes through the selection of appropriate mesh opening dimensions and overall device dimensions. For smaller pets, mesh openings may be sized to prevent the pet's head from extending too far through the opening. For larger pets, mesh openings may be sized to allow the pet's snout to protrude while preventing the entire head from passing through. The frame dimensions may be adjusted through telescoping sections to match the window opening size of different vehicles, allowing a single device design to serve multiple vehicle types.

The materials selected for the device components may balance multiple performance requirements. The frame material may provide sufficient strength to resist forces applied by the pet while maintaining a weight low enough for convenient handling by the user. The mesh material may resist tearing or deformation under repeated contact with the pet's claws or teeth. The solid panel materials may maintain optical clarity over extended exposure to sunlight and temperature variations. The padding materials at attachment points may provide cushioning to protect vehicle surfaces while maintaining sufficient friction to prevent slipping.

The device may enhance the pet's travel experience by providing sensory stimulation that may reduce anxiety or stress during vehicle travel. The ability to smell outdoor air and observe the passing environment may engage the pet's natural curiosity and provide mental stimulation. This engagement may reduce undesirable behaviors such as excessive vocalization, restlessness, or attempts to escape from restraints. The pet may associate vehicle travel with positive experiences, potentially making future travel easier for both the pet and the owner.

The device may also enhance safety for human occupants of the vehicle. By containing the pet in a specific area near the window, the device may prevent the pet from moving freely throughout the vehicle cabin. This containment may reduce driver distraction caused by the pet moving into the driver's field of view or interfering with vehicle controls. The device may allow the driver to focus on operating the vehicle while knowing that the pet is safely contained and enjoying the travel experience.

The transparent or translucent nature of the side panels may allow the driver or passengers to monitor the pet's condition without turning around or leaving their seats. Visual observation through the panels may enable quick detection of any signs of distress or discomfort in the pet. This monitoring capability may be particularly valuable during long trips or in varying weather conditions where the pet's comfort level may change over time.

The device may provide a barrier that prevents the pet from interacting with objects or individuals outside the vehicle in an uncontrolled manner. When the vehicle is stopped at a traffic light or in a parking area, the device may prevent the pet from attempting to exit the vehicle to approach other animals or people. This containment may reduce the risk of the pet escaping and becoming lost or injured. The device may also prevent other individuals from reaching into the vehicle to interact with the pet without the owner's knowledge or consent.

The mesh screen may filter airborne particles to some degree, potentially reducing the pet's exposure to dust, pollen, or other allergens present in the outdoor air. While the mesh openings may be large enough to allow substantial airflow, they may be small enough to block larger particles. This filtration effect may be beneficial for pets with respiratory sensitivities or allergies, allowing them to enjoy outdoor air with reduced exposure to irritants.

The device may be used in conjunction with other pet safety equipment such as harnesses or seat belt attachments. The device may serve as a secondary containment system that provides an additional layer of protection beyond the primary restraint. If the primary restraint were to fail or if the pet were to slip out of a harness, the device may prevent the pet from exiting the vehicle through the window opening. This redundancy may enhance overall safety during travel.

The device may be particularly useful for pet owners who frequently travel with their pets and desire a consistent safety solution across different trips and vehicles. The portability and adjustability of the device may allow it to be used in multiple vehicles owned by the same person or in rental vehicles during vacation travel. The device may provide a familiar environment for the pet across different travel scenarios, potentially reducing stress associated with unfamiliar vehicles or travel routes.

Embodiments of the present disclosure may comprise methods, systems, and a computer readable medium comprising, but not limited to, at least one of the following:
A. A Frame
B. Side Panels
C. A Front Panel
D. A Top Panel
E. A Bottom Panel
F. An Attachment Mechanism

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

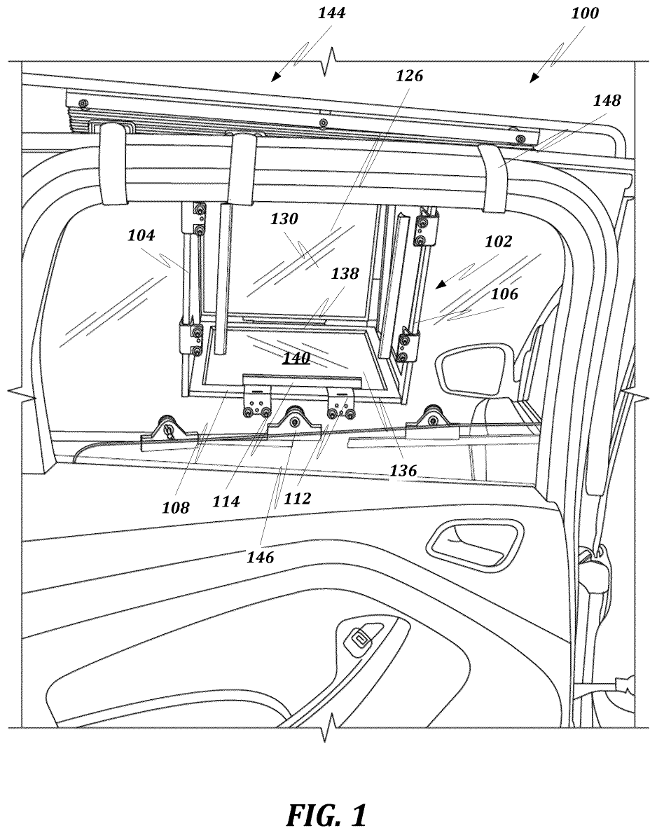

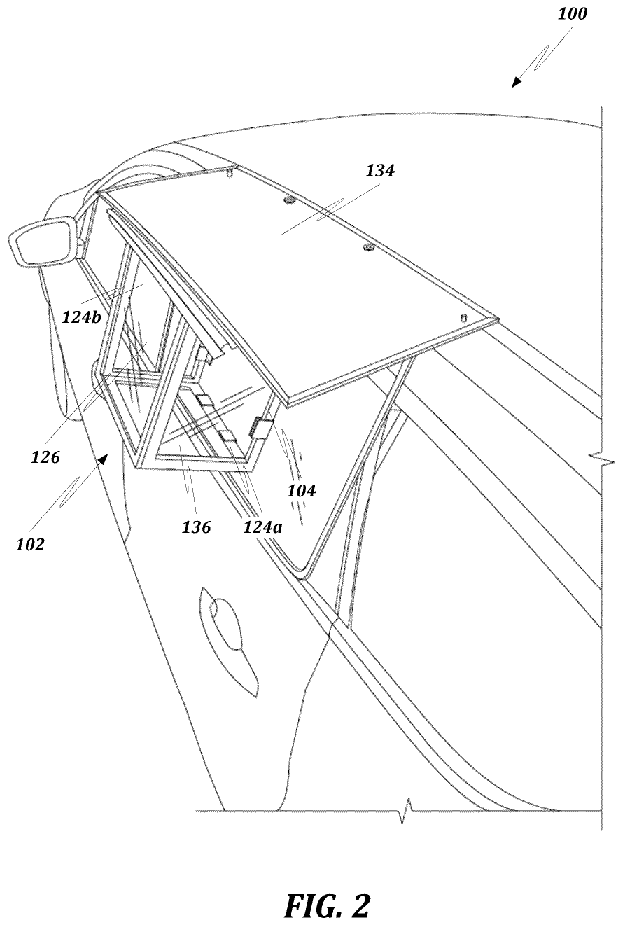

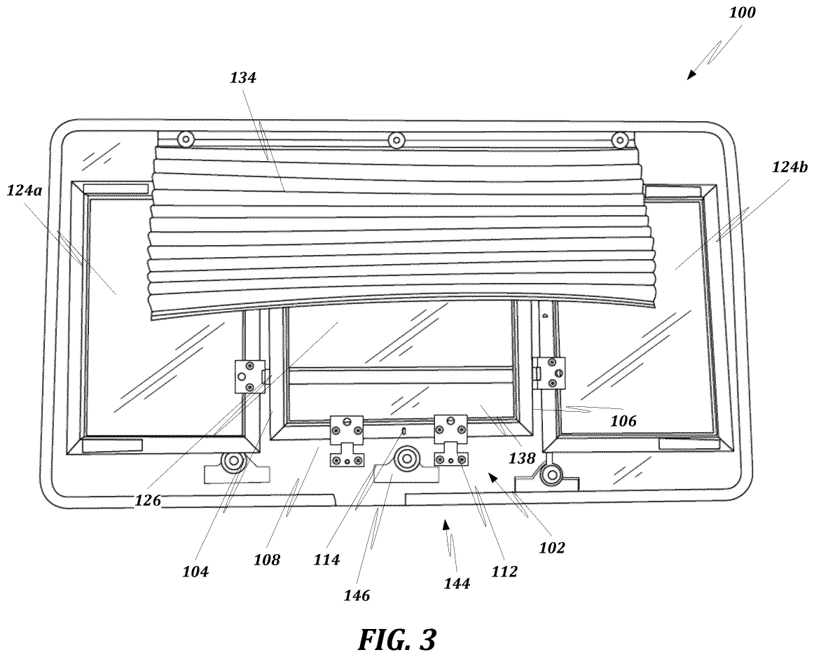

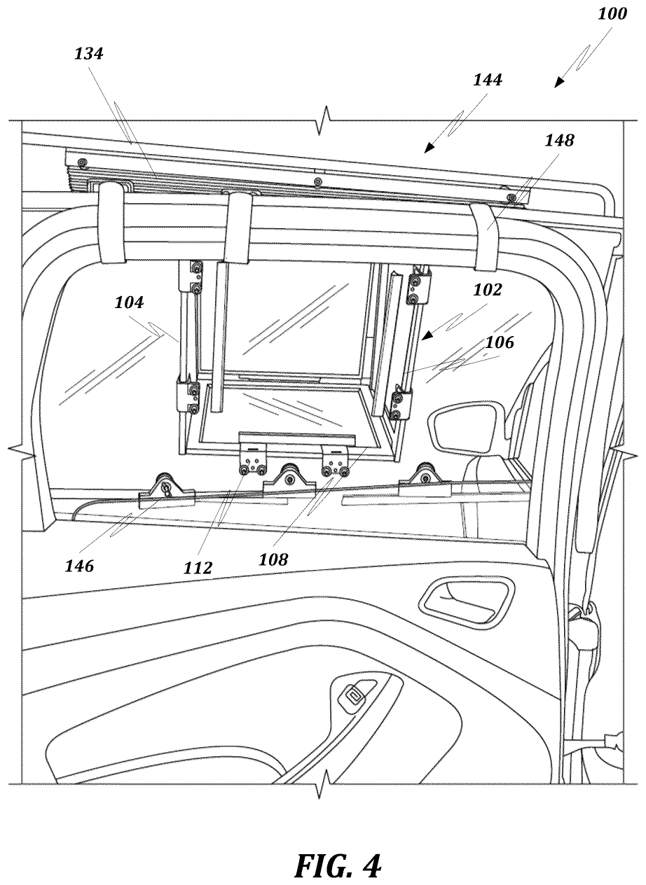

FIGS. 1-5 illustrate one possible embodiment of a pet-safety vehicle window insert device 100. Embodiments of the present disclosure provide a device comprised of a set of elements, including, but not limited to:

### A. A Frame

The device 100 may include a frame 102. The frame 102 of the device 100 may be constructed from lightweight yet durable materials such as aluminum, steel, and/or reinforced plastic. The frame may have a generally rectangular shape designed to fit within a vehicle window opening. The frame may include vertical and horizontal support members to provide structural integrity.

The frame 102 may feature a folding or collapsible design to allow for compact storage when not in use. Hinges or pivoting joints may be incorporated at key points to enable the frame to fold substantially flat. When unfolded and installed, the frame may provide a rigid structure to support the mesh screen and side panels. In some embodiments, the hinges or pivoting joints may include locks to reinforce the rigidity of the frame in the unfolded configuration.

The overall dimensions of the frame may be adjustable to accommodate different vehicle window sizes. Telescoping sections or interchangeable frame pieces may provide this adaptability.

The frame 102 may comprise a plurality of interconnected structural members that collectively define a perimeter structure. The frame 102 may include a first vertical member 104. The first vertical member 104 may extend along a first lateral edge of the frame 102. The frame 102 may include a second vertical member 106. The second vertical member 106 may extend along a second lateral edge of the frame 102. The second lateral edge may be opposite to the first lateral edge. The frame 102 may include a first horizontal member 108. The first horizontal member 108 may extend along an upper edge of the frame 102. The frame 102 may include a second horizontal member 110. The second horizontal member 110 may extend along a lower edge of the frame 102.

The first vertical member 104 may be coupled to the first horizontal member 108 at a first corner joint, and to the second horizontal member 110 at a second corner joint. The second vertical member 106 may be coupled to the first horizontal member 108 at a third corner joint, and to the second horizontal member 110 at a fourth corner joint.

Each of the corner joints may include a hinge mechanism 112. The hinge mechanism 112 may permit rotational movement of adjacent frame members relative to one another. The hinge mechanism 112 may allow the frame 102 to transition between a deployed configuration and a folded configuration. In the deployed configuration, the first vertical member 104 and the second vertical member 106 may be substantially perpendicular to the first horizontal member 108 and the second horizontal member 110. In the folded configuration, the first vertical member 104, the second vertical member 106, the first horizontal member 108, and the second horizontal member 110 may be substantially parallel to one another.

The frame 102 may include a locking mechanism 114. The locking mechanism 114 may be associated with at least one of the corner joints. The locking mechanism 114 may secure the frame 102 in the deployed configuration. The locking mechanism 114 may prevent unintended folding of the frame 102 during use. As one non-limiting example, the locking mechanism 114 may include a spring-loaded pin. The spring-loaded pin may engage with a corresponding aperture in an adjacent frame member. The locking mechanism 114 may include a lever actuator. The lever actuator may allow a user to disengage the spring-loaded pin from the corresponding aperture.

Each member 104, 106, 108, 110 may include a telescoping section, which may allow adjustment of a length of the member. Each telescoping section may include an inner tube and an outer tube. The inner tube may be slidably received within the outer tube. The telescoping section may include a locking collar configured to secure the inner tube at a selected position relative to the outer tube.

The frame 102 may include a first channel formed along an inner edge of the first vertical member 104. The first channel may be configured to receive an edge of a panel component. The frame 102 may include a second channel formed along an inner edge of the second vertical member 106. The frame 102 may include a third channel formed along an inner edge of the first horizontal member 108. The frame 102 may include a fourth channel formed along an inner edge of the second horizontal member 110.

Each of the first channel, the second channel, the third channel, and the fourth channel may have a substantially U-shaped cross-sectional profile. Each channel may have a depth designed to receive and retain a panel. For example, the depth dimension ranging from approximately 0.25 inches to approximately 0.75 inches. Each channel may have a width dimension slightly larger than a thickness of a panel component to be received therein.

The frame 102 may be fabricated from a metallic material. The metallic material may be aluminum alloy. The aluminum alloy may provide a favorable strength-to-weight ratio. The frame 102 may alternatively be fabricated from a reinforced polymeric material. The reinforced polymeric material may include fiber-reinforced composite structures. The frame 102 may have a tubular cross-section. The tubular cross-section may be hollow. The tubular cross-section may have an outer diameter ranging from approximately 0.5 inches to approximately 1.5 inches. The tubular cross-section may have a wall thickness ranging from approximately 0.05 inches to approximately 0.15 inches.

The frame 102 may include a protective coating. The protective coating may be applied to exterior surfaces of the frame members. The protective coating may be an anodized finish. The protective coating may alternatively be a powder-coated finish. The protective coating may provide corrosion resistance. The protective coating may provide resistance to environmental degradation.

### B. Side Panels

The device 100 may include a pair of side panels 124. The side panels 124 may be constructed from a durable materials such as acrylic, polycarbonate plastic, tempered glass, and/or the like. In some embodiments, the panels may be transparent. The transparent panels may allow for pets to see out through the panels, as well as allowing users to observe the pet through the panels from the vehicle exterior. Alternatively, opaque or translucent panels may be used to help reduce exposure of the vehicle interior to sunlight. The panels may include one or more coatings such as (but not limited to) a tinted coating, a UV-blocking coating, a polarized coating, and/or any other coating that may provide protection from sunlight or other elements.

The side panels 124 may be positioned on opposite lateral edges of the frame 102. A first side panel 124a may be coupled to the first vertical member 104. A second side panel 124b may be coupled to the second vertical member 106. Each side panel 124 may extend along substantially the full height of the respective vertical member 104, 106 to which it may be coupled. The first side panel 124a may provide a lateral barrier along the first lateral edge of the device 100. The second side panel 124b may provide a lateral barrier along the second lateral edge of the device 100.

Each side panel 124 may have a thickness dimension, which may range, as a non-limiting example, from approximately 0.06 inches to approximately 0.25 inches. Each side panel 124 may have optical properties. The optical properties may include transparency. The optical properties may alternatively include translucency or opacity.

Each side panel 124 may include one or more coatings applied to at least one surface thereof. The one or more coatings may include a UV-blocking coating. The UV-blocking coating may absorb and/or reflect ultraviolet radiation. The coating may be a tinted coating configured to reduce visible light transmission through the side panel 124. The one or more coatings may include a polarized coating. The polarized coating may reduce glare from reflected light. The one or more coatings may include an anti-scratch coating. The anti-scratch coating may be a hardened surface layer.

Each side panel 124 may have a height dimension that substantially matches the height of the frame 102. The height dimension may extend from the first horizontal member 108 to the second horizontal member 110. Each side panel 124 may have a width dimension that may range from approximately 3 inches to approximately 8 inches. The width dimension may be selected to provide adequate lateral coverage and to prevent lateral egress of a pet.

Each side panel 124 may be coupled to the frame 102 through a sliding engagement mechanism. The first side panel 124a may be received within the first channel of the first vertical member 104. The second side panel 124b may be received within the second channel of the second vertical member 106. Each side panel 124 may be inserted into the respective channel from a top end or a bottom end of the frame 102. Each side panel 124 may be retained within the respective channel. For example, the side panels 124 may be retained by a friction fit, a snap-fit engagement, and/or any other retention mechanism.

Each side panel 124 may optionally include an edge treatment. The edge treatment may be applied to peripheral edges of the side panel 124. The edge treatment may include rounded edges. The rounded edges may have a radius dimension. The radius dimension may range from approximately 0.06 inches to approximately 0.25 inches. The edge treatment may alternatively include beveled edges. The beveled edges may have a bevel angle. The bevel angle may range from approximately 30 degrees to approximately 60 degrees. The edge treatment may prevent or reduce sharp edges that could cause injury to a pet or a user.

Each side panel 124 may optionally include ventilation features. The ventilation features may be perforations. The perforations may be an array of holes or slots that may be sized to permit airflow while preventing objects of substantial size from passing therethrough.

Each side panel 124 may be removable from the frame 102. The removability may facilitate cleaning and/or replacement of the side panels 124. Each side panel 124 may be removed by sliding the panel out of the respective channel. In embodiments, the removal may be accomplished without the use of tools.

Each side panel 124 may include attachment features for coupling to the frame 102 through alternative mechanisms. The attachment features may be snap-fit connectors (e.g., clips). The clips may be attached to edges of the side panel 124 and may engage with corresponding features on the frame 102. The snap-fit connectors may allow quick attachment and/or detachment of the side panel 124.

Each side panel 124 may optionally have a surface texture (e.g., smooth). The surface texture may alternatively include a pattern. The pattern may be a matte finish. The matte finish may reduce glare. The pattern may alternatively be a textured surface. The textured surface may enhance grip for handling.

Each side panel 124 may provide a visual barrier. The visual barrier may allow a pet to observe an exterior environment through the side panel 124 when the side panel is transparent or translucent. The visual barrier may prevent external individuals from directly contacting the pet. The visual barrier may maintain a connection between the pet and surrounding environment while providing physical separation.

Each side panel 124 may provide a weather barrier. The weather barrier may deflect rain and/or other precipitation, wind, and/or debris from entering laterally through the device 100. The weather barrier may protect the pet from lateral environmental intrusion. The weather barrier may protect the vehicle interior from lateral environmental intrusion.

### C. A Front Panel

The device 100 may include a front panel 126. The front panel 126 may be coupled to the frame 102. The front panel 126 may span an opening defined by the frame 102. The front panel 126 may optionally include a mesh screen portion. The mesh screen portion may be configured to permit airflow while preventing a pet from passing therethrough.

The mesh screen portion may be fabricated from a mesh material, such as nylon and/or metal wire (e.g., stainless steel, aluminum alloy, etc.). The mesh material may have a tensile strength sufficient to resist forces applied by a pet. As specific examples, the tensile strength may range from approximately 50 pounds to approximately 200 pounds.

The mesh screen portion may be attached to the frame 102 along a perimeter edge of the mesh screen portion. The perimeter edge may be secured within a channel formed in the frame 102. The perimeter edge may alternatively be secured by a clamping bar, which may extend along at least one edge of the mesh screen portion. The mesh screen portion may be maintained in a tensioned state. The tensioned state may prevent sagging of the mesh material.

The mesh screen portion may include edge reinforcement. The edge reinforcement may be applied to the perimeter edge. The edge reinforcement may be a doubled layer of mesh material. The edge reinforcement may alternatively be a binding tape, a plastic edge strip, a metal edge strip, and/or the like. The edge reinforcement may resist fraying of the mesh material. The edge reinforcement may resist tearing of the mesh material.

The front panel 126 may include a solid portion 130. The solid portion 130 may be positioned within an upper region of the front panel 126. The solid portion 130 may be positioned above the mesh screen portion. The solid portion 130 may be configured to prevent precipitation from entering a vehicle interior. The solid portion 130 may be configured to deflect rain, snow, wind, debris, etc.

The solid portion 130 may be fabricated from a transparent material. The transparent material may be acrylic, polycarbonate, tempered glass, etc., The solid portion 130 may have a thickness that may range from approximately 0.06 inches to approximately 0.25 inches. The solid portion 130 may allow light transmission therethrough. The solid portion 130 may allow a pet to observe an exterior environment through the solid portion.

The solid portion 130 may include one or more optical coatings. The one or more coatings may include a UV-blocking coating that may absorb and/or reflect ultraviolet radiation. The one or more coatings may include a tinted coating configured to reduce visible light transmission. The one or more coatings may include an anti-scratch coating. The anti-scratch coating may be a hardened surface layer.

In some embodiments, the solid portion 130 may be coupled to the mesh screen portion at a transition zone. The transition zone may be a seam. The seam may be formed by sewing or other bonding methods (e.g., adhesive bonding, thermal bonding, etc.). In other embodiments, the solid portion 130 and the mesh portion may overlap without any bonding.

The transition zone may include a weatherproof seal. The weatherproof seal may prevent moisture intrusion at the transition zone. The weatherproof seal may be formed as a gasket.

The front panel 126 may be removable from the frame 102. The removability may facilitate cleaning and/or replacement of the front panel 126. The front panel 126 may be removed by sliding the front panel 126 out of the channel. The removal may be accomplished without tools.

The front panel 126 may include attachment features configured to couple the front panel 126 to the frame 102. The attachment features may be snap-fit connectors, such as clips. The clips may be attached to edges of the front panel 126 and may engage with corresponding features on the frame 102. The snap-fit connectors may allow quick attachment and/or detachment of the front panel 126.

### D. A Top Panel

The device 100 may include a top panel 134. The top panel 134 may be positioned along an upper edge of the frame 102. The top panel 134 may extend horizontally across a width of the frame 102. The top panel 134 may be coupled to the first horizontal member 108. The top panel 134 may provide overhead protection from environmental elements.

The top panel 134 may be fabricated from a rigid material. The rigid material may be acrylic or polycarbonate. The rigid material may alternatively be tempered glass. The top panel 134 may have a thickness dimension. The thickness dimension may range from approximately 0.06 inches to approximately 0.25 inches.

The top panel 134 may have optical properties. The optical properties may include transparency, translucency, or opacity. Transparency and translucency may allow light transmission through the top panel 134. Moreover, transparency may permit a pet to observe an overhead environment. The light transmission may permit natural illumination of an interior space beneath the top panel 134.

The top panel 134 may include one or more optical coatings. The one or more coatings may be applied to at least one surface of the top panel 134. The one or more coatings may include a UV-blocking coating. The UV-blocking coating may absorb and/or reflect ultraviolet radiation. The one or more coatings may include a tinted coating. The tinted coating may reduce visible light transmission. The one or more coatings may include an anti-scratch coating. The anti-scratch coating may be a hardened surface layer.

In some embodiments, the top panel 134 may have a substantially planar geometric configuration. In other embodiments, the top panel 134 may have a curved (e.g., arcuate) geometric configuration. The curvature may be a slight arc (e.g., an arc having a radius dimension in the range from approximately 24 inches to approximately 60 inches). The curvature may facilitate water runoff, directing the runoff away from the mesh screen portion.

The top panel 134 may include a slope. The slope may be an angular deviation from horizontal. The angular deviation may range from approximately 1 degree to approximately 5 degrees. The slope may be oriented to direct water toward an exterior side of the device 100, which may help to reduce or prevent water accumulation on the top panel 134.

The top panel 134 may have a width that substantially matches a width of the frame 102. The width dimension may extend from the first vertical member 104 to the second vertical member 106. The top panel 134 may have a depth extending from a front edge to a rear edge of the top panel 134. The depth dimension may range from approximately 3 inches to approximately 10 inches.

The top panel 134 may be coupled to the frame 102 through a sliding engagement mechanism. The top panel 134 may be received within the third channel of the first horizontal member 108. The top panel 134 may be inserted into the third channel from a first end or a second end of the first horizontal member 108. The top panel 134 may be retained within the third channel by a friction fit, a snap-fit engagement, and/or the like.

The top panel 134 may include attachment features (e.g., clips, brackets, etc.) configured to couple the top panel 134 to the frame 102. The features may be attached to edges of the top panel 134 and may engage with corresponding features on the first horizontal member 108.

The top panel 134 may be removable from the frame 102. The removability may facilitate cleaning and/or replacement of the top panel 134. The top panel 134 may be removed by sliding the top panel 134 out of the third channel. The removal may be accomplished without tools.

The top panel 134 may act as a barrier, preventing debris, as well as rain, snow, and/or other precipitation from entering a vehicle through the device 100. The barrier may protect a pet from overhead environmental intrusion.

### E. A Bottom Panel

A bottom panel 136 may be coupled to the frame 102 of the device 100. The bottom panel 136 may be positioned along a lower edge of the frame 102. The bottom panel 136 may extend horizontally across a width of the frame 102. The bottom panel 136 may be coupled to the second horizontal member 110. The bottom panel 136 may provide a base support structure for the device 100.

The bottom panel 136 may be fabricated from a rigid material, such as (but not limited to) reinforced plastic (e.g., acrylonitrile butadiene styrene (ABS), polypropylene, etc.), aluminum sheeting, and/or the like. The bottom panel 136 may have a thickness selected to offer support to a pet. The thickness may range from approximately 0.06 inches to approximately 0.25 inches.

The bottom panel 136 may have a width that substantially matches a width of the frame 102. The width may extend from the first vertical member 104 to the second vertical member 106. The bottom panel 136 may have a depth ranging from approximately 3 inches to approximately 10 inches.

The bottom panel 136 may include an edge lip 138 positioned along the front edge of the bottom panel 136. The edge lip 138 may extend upward from a planar surface 140 of the bottom panel 136. The edge lip 138 may have a height ranging from approximately 0.25 inches to approximately 1 inch, and may be configured to help prevent water (e.g., from precipitation or water runoff) and/or debris from entering a vehicle interior. The planar surface 140 of bottom panel 136 may include a textured surface, such as a non-slip surface that may provide traction for a pet's paws.

The bottom panel 136 may include one or more drainage holes. The drainage holes may be formed through the bottom panel 136. The drainage holes 12 may extend from the planar surface 140 through to a lower surface of the bottom panel 136. The drainage holes may have a diameter ranging from approximately 0.125 inches to approximately 0.25 inches. The drainage holes may allow accumulated moisture to escape from the device 100. The drainage holes may be positioned to drain away from the vehicle interior.

The bottom panel 136 may be coupled to the frame 102 through a sliding engagement mechanism. The bottom panel 136 may be received within the fourth channel of the second horizontal member 110. The bottom panel 136 may be inserted into the fourth channel from a first end or a second end of the second horizontal member 110. The bottom panel 136 may be retained within the fourth channel by a friction fit, a snap-fit engagement, and/or the like.

The bottom panel 136 may include attachment features (e.g., clips, brackets, etc.). The attachment features may be configured to couple the bottom panel 136 to the frame 102. The attachment features may be attached to edges of the bottom panel 136 and may engage with corresponding features on the second horizontal member 110.

The bottom panel 136 may include reinforced attachment points located where the bottom panel 136 connects to the frame 102. The reinforced attachment points may include thickened sections of the bottom panel material. The reinforced attachment points may provide increased strength to support a pet's weight.

The bottom panel 136 may be removable from the frame 102. The removability may facilitate cleaning and/or replacement of the bottom panel 136. The bottom panel 136 may be removed by sliding the bottom panel 136 out of the fourth channel. The removal may be accomplished without tools.

### F. An Attachment Mechanism

The device 100 may include one or more attachment mechanisms 144 designed to securely fasten the frame 102 to the vehicle window and/or door. The mechanism 144 may be made of durable materials such as stainless steel or reinforced plastic to withstand the forces exerted by a pet (e.g., a dog, cat, etc.).

The attachment mechanism 144 may include a first hook assembly 146. The first hook assembly 146 may be configured to engage a top edge of the vehicle window glass. The first hook assembly 146 may be formed as a hook body having a generally J-shaped or L-shaped geometric configuration. The hook body may be fabricated from a metallic material, such as (but not limited to) stainless steel or a reinforced polymeric material. The hook may have a depth ranging from approximately 0.5 inches to approximately 2 inches to facilitate retention by the vehicle window glass.

The first hook assembly 146 may include a padding element disposed on a contact surface of the hook body. The padding element may be fabricated from a resilient material, such as rubber, silicone, foam, and/or the like. The padding element may be configured to reduce or prevent scratching of the vehicle window glass. The padding element may increase a friction coefficient between the hook body and the vehicle window glass, helping to retain the device 100 in position. The resilient member may further serve to dampen vibrations between the hook assembly 146 and the window glass, reducing noise and vibration.

The attachment mechanism 144 may include a second hook assembly 148. The second hook assembly 148 may be configured to engage a door frame structure of the vehicle. The second hook assembly 148 may include a hook body having a generally J-shaped or L-shaped geometric configuration. The hook may be fabricated from a metallic material (e.g., stainless steel), a reinforced polymeric material, and/or the like. The hook body may have a hook depth ranging from approximately 0.5 inches to approximately 2 inches.

The second hook assembly 148 may include a padding element disposed on a contact surface of the hook. The padding element may be fabricated from a resilient material, such as rubber, silicone, foam, and/or the like. The padding element may be configured to reduce or prevent damage to the door frame structure. The padding element may increase a friction coefficient between the hook and the door frame structure, helping to retain the device 100 in position. The resilient member may further serve to dampen vibrations between the hook assembly 148 and the door frame structure, reducing noise and vibration.

In some embodiments, the attachment mechanism 144 may include a first clamp assembly. The first clamp assembly may be positioned along a first lateral edge of the frame 102. The first clamp assembly may be configured to engage a window frame structure of the vehicle. The first clamp assembly may include a clamp body. The clamp body may have a generally C-shaped cross-sectional configuration. The clamp body may be fabricated from a metallic material, such as steel or aluminum alloy.

The first clamp assembly may include a fixed jaw member and a movable jaw member, configured to move relative to the fixed jaw member. An adjustment mechanism may be configured to control a spacing between the fixed jaw member and the movable jaw member.

The first clamp assembly may include a first contact pad disposed on a contact surface of the fixed jaw member, and a second contact pad disposed on a contact surface of the movable jaw member. The contact pads may be fabricated from a resilient material, such as rubber, silicone, foam, and/or the like. The resilient material may increase a friction coefficient between the first clamp assembly and the window frame structure, and may help to reduce or prevent damage to the window frame structure. The resilient members may further serve to dampen vibrations between the clamp assembly and the window frame structure, reducing noise and vibration.

The attachment mechanism 144 may include a second clamp assembly. The second clamp assembly may be positioned along a second lateral edge of the frame 102. The second clamp assembly may be configured to engage a window frame structure of the vehicle. The second clamp assembly may include a clamp body. The clamp body may have a generally C-shaped cross-sectional configuration. The clamp body may be fabricated from a metallic material, such as steel or aluminum alloy.

The second clamp assembly may include a fixed jaw member and a movable jaw member, configured to move relative to the fixed jaw member. An adjustment mechanism may be configured to control a spacing between the fixed jaw member and the movable jaw member.

The second clamp assembly may include a first contact pad disposed on a contact surface of the fixed jaw member, and a second contact pad disposed on a contact surface of the movable jaw member. The contact pads may be fabricated from a resilient material, such as rubber, silicone, foam, and/or the like. The resilient material may increase a friction coefficient between the second clamp assembly and the window frame structure, and may help to reduce or prevent damage to the window frame structure. The resilient members may further serve to dampen vibrations between the clamp assembly and the window frame structure, reducing noise and vibration.

The attachment mechanism 144 may include a quick-release mechanism. The quick-release mechanism may be associated with at least one of the first hook assembly 146, the second hook assembly 148, the first clamp assembly, or the second clamp assembly. The quick-release mechanism may be configured to allow rapid detachment of the attachment mechanism 144 from the vehicle. The quick-release mechanism may include a spring-loaded pin element. The spring-loaded pin element may engage with a corresponding aperture in an adjacent component. The quick-release mechanism may include an actuator configured to disengage the spring-loaded pin element from the corresponding aperture when actuated by a user.

### III. Platform Operation

The methods described herein may be performed by one or more actors. The actors may include, but are not limited to, a user, a pet owner, a vehicle operator, an installer, a maintenance technician, or any combination thereof. The stages of the methods may be performed in the order described, or may be reordered, combined, separated, or performed in parallel without departing from the scope of the disclosure. Additional stages may be added, and certain stages may be omitted, modified, or repeated as circumstances require. The methods may be embodied as manual procedures performed by human actors.

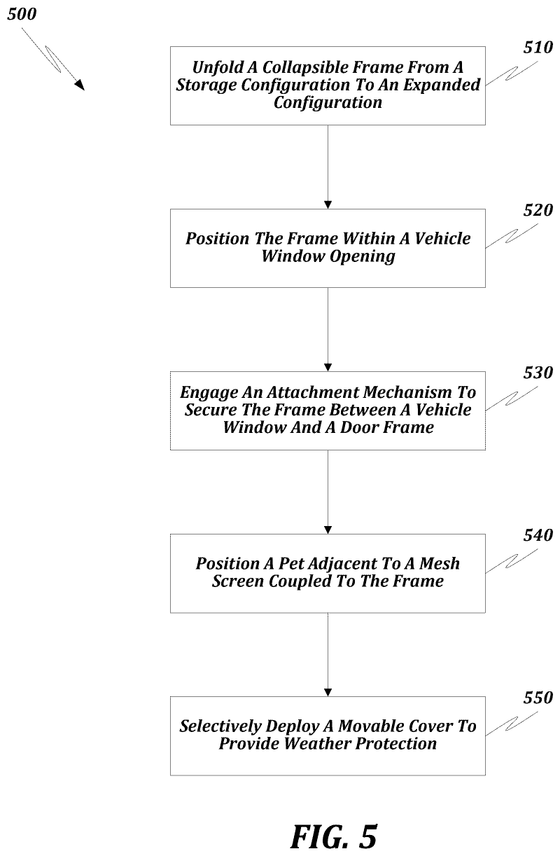

As shown in FIG. 5, a method 500 of installing the device 100 may be performed. The method 500 may begin with retrieval of the device 100 from a storage location. The storage location may be a vehicle trunk, a cargo compartment, a garage, a closet, or any other suitable storage area. The device 100 may be in a folded configuration when retrieved. The folded configuration may have a substantially flat profile with a thickness ranging from approximately 1 inch to approximately 3 inches.

At stage 510, the frame 102 may be unfolded from the folded configuration to a deployed configuration. The unfolding may be performed by grasping the frame 102 at designated handle points or grip areas. Force may be applied to separate hinged sections of the frame 102. The frame members may rotate about hinge axes until the deployed configuration is reached. The deployed configuration may have corner angles of approximately 90 degrees, forming a substantially rectangular perimeter.

Locking mechanisms 114 may be engaged to secure the frame 102 in the deployed configuration. The locking mechanisms 114 may engage automatically as the frame 102 reaches the deployed position. Alternatively, the locking mechanisms 114 may be manually engaged by a user. The engagement may involve spring-loaded pins snapping into locking holes, lever locks being actuated, or toggle clamps being closed. The frame 102 may be verified to be rigid by attempting to compress or flex the frame 102.

The frame 102 may be adjusted to match dimensions of a vehicle window opening. Telescoping sections may be extended or retracted to adjust a width dimension of the frame 102. Telescoping sections may be extended or retracted to adjust a height dimension of the frame 102. Locking collars may be tightened to secure the telescoping sections at selected positions. The adjusted dimensions may be verified by positioning the frame 102 adjacent to the vehicle window opening.

Panels may be installed into the frame 102 if not already installed. The front panel 126 may be aligned with a front opening of the frame 102. Edges of the front panel 126 may be inserted into the channels formed in the frame 102. The front panel 126 may be slid fully into position within the channels. The front panel 126 may be verified to be securely seated by applying a pulling force to the front panel 126.

The first side panel 124a may be aligned with the first channel of the first vertical member 104. The first side panel 124a may be inserted into the first channel from a top end or a bottom end of the frame 102. The first side panel 124a may be slid fully into the first channel. The second side panel 124b may be aligned with the second channel of the second vertical member 106. The second side panel 124b may be inserted into the second channel from a top end or a bottom end of the frame 102. The second side panel 124b may be slid fully into the second channel.

The top panel 134 may be aligned with the third channel of the first horizontal member 108. The top panel 134 may be inserted into the third channel from a first end or a second end of the first horizontal member 108. The top panel 134 may be slid fully into the third channel. The bottom panel 136 may be aligned with the fourth channel of the second horizontal member 110. The bottom panel 136 may be inserted into the fourth channel from a first end or a second end of the second horizontal member 110. The bottom panel 136 may be slid fully into the fourth channel.

At stage 520, the frame 102 may be positioned within a vehicle window opening. The vehicle window may be positioned to receive the device 100. The vehicle window may be lowered to a position that allows installation of the device 100. The lowered position may place a top edge of the window glass at a height ranging from approximately 3 inches to approximately 6 inches below a top edge of a door frame. The lowered position may be achieved by operating a power window control or a manual window crank.

The frame 102 may be aligned such that lower attachment assemblies of the attachment mechanism 144 are positioned to engage the top edge of the window glass. The frame 102 may be held in position by a user while the vehicle window is raised. The vehicle window may be raised by operating the power window control or the manual window crank. The window glass may lift the frame 102 as the window rises.

At stage 530, an attachment mechanism may be engaged to secure the frame 102 between a vehicle window and a vehicle door frame. As examples, securing the attachment mechanism 144 may include securing one or more of the first hook assembly 146, the second hook assembly 148, the first clamp assembly, and the second clamp assembly.

The first hook assembly 146 may engage a top edge of the door frame or a windowsill structure. The engagement may occur when the window glass has lifted the frame 102 to a height where the first hook assembly 146 contacts the door frame structure. The hook body of the first hook assembly 146 may extend over the door frame structure. The padding element of the first hook assembly 146 may contact a surface of the door frame structure.

The second hook assembly 148 may engage the door frame structure. The hook body of the second hook assembly 148 may extend over a portion of the door frame structure. The padding element of the second hook assembly 148 may contact a surface of the door frame structure. The frame 102 may be suspended between the window glass below and the door frame structure above.

The first clamp assembly may be positioned to engage a window frame structure along a first lateral edge of the vehicle window opening. The first clamp assembly may be adjusted to align with the window frame structure. The adjustment mechanism of the first clamp assembly may be actuated to move the movable jaw member toward the fixed jaw member. The movable jaw member may be tightened until the first contact pad and the second contact pad firmly grip the window frame structure.

The second clamp assembly may be positioned to engage a window frame structure along a second lateral edge of the vehicle window opening. The second clamp assembly may be adjusted to align with the window frame structure. The adjustment mechanism of the second clamp assembly may be actuated to move the movable jaw member toward the fixed jaw member. The movable jaw member may be tightened until the first contact pad and the second contact pad firmly grip the window frame structure.

The attachment mechanism 144 may be verified to be secure. The frame 102 may be subjected to a pulling force to verify that the attachment mechanism 144 resists displacement. The frame 102 may be subjected to a pushing force to verify that the attachment mechanism 144 resists displacement. The frame 102 may be subjected to a lateral force to verify that the attachment mechanism 144 resists displacement.

At stage 540, the pet may be positioned adjacent to the device 100. The pet may be allowed to approach the mesh screen portion of the front panel 126. The pet may extend its head through the mesh screen portion to experience airflow and observe an exterior environment. The pet may be monitored to ensure the pet remains safe and comfortable.

Stage 550 may include selectively deploying a movable cover. For example, the retractable cover shade may be deployed if weather conditions change. A user may grasp a shade handle or pull-tab of the retractable cover shade. The user may apply a downward force to unroll the shade from a roller mechanism. The shade may descend over the mesh screen portion. The shade may be pulled to a desired extent to provide partial or full coverage of the mesh screen portion. The shade may lock in position via detents or friction mechanisms.

The retractable cover shade may be retracted when weather conditions improve. The user may release the shade handle or activate a release mechanism. A torsion spring in the roller mechanism may exert torque on a roller tube. The roller tube may rotate, winding the shade material back onto the roller tube. The shade may retract upward, uncovering the mesh screen portion.

In a method of removing the device 100, the pet may be removed from the device area. The pet may be directed away from the window opening. The pet may be placed inside a building, secured with a leash, or otherwise restrained to prevent the pet from approaching the device 100 during removal.

The attachment mechanism 144 may be disengaged. The first clamp assembly may be loosened by reversing the adjustment mechanism. The movable jaw member of the first clamp assembly may be moved away from the fixed jaw member. The second clamp assembly may be loosened by reversing the adjustment mechanism. The movable jaw member of the second clamp assembly may be moved away from the fixed jaw member.

Quick-release mechanisms may be activated. A user may press buttons, flip levers, or otherwise actuate the quick-release mechanisms. Spring-loaded pin elements may disengage from corresponding apertures. The first hook assembly 146 may be disengaged from the door frame structure. The second hook assembly 148 may be disengaged from the door frame structure.

The vehicle window may be lowered. The power window control or manual window crank may be operated to lower the window glass. The window glass may descend, allowing the frame 102 to descend with the window glass. The frame 102 may be lifted out of the window opening once the window glass has been lowered sufficiently.

The frame 102 may be removed from the vehicle. The frame 102 may be lifted away from the window opening. The frame 102 may be carried to a location for folding and storage.

Panels may be removed from the frame 102 if desired. The front panel 126 may be slid out of the channels. The first side panel 124a may be slid out of the first channel. The second side panel 124b may be slid out of the second channel. The top panel 134 may be slid out of the third channel. The bottom panel 136 may be slid out of the fourth channel. The panels may be cleaned, inspected, or stored separately.

The frame 102 may be folded to the folded configuration. Locking mechanisms 114 may be disengaged. The user may press buttons, flip levers, or otherwise actuate the locking mechanisms 114 to disengage spring-loaded pins from locking holes. The frame members may be rotated about hinge axes. The frame 102 may be collapsed until the frame members are substantially parallel to one another. The folded configuration may have a substantially flat profile.

The folded frame 102 may be secured with straps or clips if provided. The straps or clips may prevent the frame 102 from unfolding unintentionally during storage or transport. The folded frame 102 may be placed in a protective bag or case if provided. The protective bag or case may protect the frame 102 from scratches, dust, or other damage during storage.

The device 100 may be stored in a storage location. The storage location may be a vehicle trunk, a cargo compartment, a garage, a closet, or any other suitable storage area. The device 100 may remain in the storage location until needed for future use.

A method of maintaining the device 100 may be performed. The device 100 may be inspected periodically for wear or damage. The frame 102 may be inspected for cracks, bends, or other structural damage. The mesh screen portion may be inspected for tears, fraying, or other damage. The side panels 124, the top panel 134, and the bottom panel 136 may be inspected for cracks, scratches, or other damage. The attachment mechanism 144 may be inspected for wear, corrosion, or other damage.

The device 100 may be cleaned periodically. The panels may be removed from the frame 102. The panels may be washed with soap and water. The panels may be rinsed with clean water. The panels may be dried with a soft cloth or allowed to air dry. The frame 102 may be wiped with a damp cloth to remove dirt or debris. The mesh screen portion may be brushed or vacuumed to remove accumulated debris.

Worn or damaged components may be replaced. A damaged panel may be removed from the frame 102. A replacement panel may be obtained. The replacement panel may be inserted into the frame 102 in the same manner as the original panel. A damaged mesh screen portion may be removed from the frame 102. A replacement mesh screen portion may be obtained. The replacement mesh screen portion may be attached to the frame 102 in the same manner as the original mesh screen portion.

The attachment mechanism 144 may be lubricated periodically. Moving parts of the attachment mechanism 144 may be lubricated with a suitable lubricant. The lubricant may reduce friction and prevent corrosion. The lubricant may be applied to hinge mechanisms, adjustment mechanisms, and quick-release mechanisms.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A vehicle window insert device comprising:
a frame configured to attach between a vehicle window and a vehicle door;
a mesh screen coupled to the frame and configured to allow airflow while preventing a pet from exiting the vehicle;
at least one solid panel coupled to the frame and configured to provide a physical barrier; and
an attachment mechanism configured to secure the frame to the vehicle window and the vehicle door.

2. The device of claim 1, wherein the frame comprises a plurality of hinged segments configured to fold into a substantially flat configuration for storage.

3. The device of claim 2, wherein the frame further comprises at least one telescoping member configured to adjust a dimension of the frame.

4. The device of claim 1, wherein the attachment mechanism comprises:
at least one hook configured to engage a top edge of the vehicle window;
at least one side clamp configured to engage a window frame; and
padding disposed on contact surfaces of the at least one hook and the at least one side clamp.

5. The device of claim 4, wherein the attachment mechanism further comprises a quick-release mechanism configured to disengage the at least one hook and the at least one side clamp.

6. The device of claim 1, further comprising a retractable cover shade configured to selectively cover at least a portion of the mesh screen.

7. The device of claim 1, wherein the mesh screen comprises a mesh portion and a solid portion, the solid portion positioned above the mesh portion and configured to deflect precipitation.

8. A vehicle window safety system comprising:
a collapsible frame configured to attach to a vehicle window opening;
a barrier structure coupled to the frame, the barrier structure comprising a mesh portion configured to permit airflow and a solid portion configured to provide weather protection;
an attachment assembly configured to secure the frame to the vehicle at multiple contact points; and
a movable cover configured to provide selective coverage of the mesh portion.

9. The system of claim 8, wherein the collapsible frame comprises hinged segments and at least one locking mechanism configured to rigidly fix angles between the hinged segments in an expanded configuration.

10. The system of claim 8, wherein the attachment assembly comprises:
a plurality of hooks configured to engage the vehicle window;
a plurality of clamps configured to engage a door frame; and
force-distribution structures configured to distribute loads across the multiple contact points.

11. The system of claim 8, wherein the solid portion comprises side panels and a top panel, the side panels configured to prevent lateral egress and the top panel configured to provide overhead protection.

12. The system of claim 8, wherein the movable cover comprises a flexible shade material configured to roll or fold between extended and retracted positions.

13. The system of claim 8, further comprising a bottom panel coupled to the frame and comprising drainage holes configured to allow moisture to exit.

14. A pet safety apparatus for vehicle windows comprising:
a rectangular frame configured to span a vehicle window opening;
a mesh screen attached to the frame and having openings sized to prevent passage of a pet's head while permitting airflow;
solid panels attached to the frame and comprising at least side panels and a top panel;
an attachment mechanism comprising adjustable hooks and clamps configured to secure the frame to a vehicle window and door frame; and
a folding mechanism configured to collapse the frame into a substantially flat storage configuration.

15. The apparatus of claim 14, wherein the mesh screen comprises reinforced edges configured to resist damage from pet contact.

16. The apparatus of claim 14, wherein the solid panels comprise transparent or translucent material with UV-resistant coating.

17. The apparatus of claim 14, wherein the attachment mechanism further comprises ratcheting mechanisms configured to tighten the clamps against the door frame.

18. The apparatus of claim 14, further comprising ventilation openings disposed in at least one of the solid panels.

19. The apparatus of claim 14, wherein the folding mechanism comprises hinges with detent locks configured to maintain the frame in the substantially flat storage configuration.

20. A method of securing a pet in a vehicle with an open window comprising:
unfolding a collapsible frame from a storage configuration to an expanded configuration;
positioning the frame within a vehicle window opening;
engaging an attachment mechanism to secure the frame between a vehicle window and a door frame, the attachment mechanism comprising hooks and clamps;
positioning a pet adjacent to a mesh screen coupled to the frame, the mesh screen configured to allow the pet to experience airflow while preventing exit from the vehicle; and
selectively deploying a movable cover to provide weather protection over the mesh screen.
